(19) United States
(12) Patent Application Publication
(10) Pub. No.: US 2011/0158322 A1
(43) Pub. Date: Jun. 30, 2011

(54) SERVER APPARATUS, COMMUNICATION SYSTEM, AND COMMUNICATION METHOD, AND pROGRAM

(76) Inventor: Kazunori OZAWA, Tokyo (JP)

(21) Appl. No.: 13/060,985

(22) PCT Filed: Sep. 25, 2009
(86) PCT No.: PCT/JP2009/066629

§ 371 Date: Feb. 25, 2011

(51) Int. Cl. H04N 5/00; H04N 7/26

(52) U.S. Cl. 375/240.16; 348/571; 375/240.25; 375/E07.027; 348/E05.001

(57) ABSTRACT

Disclosed is a server apparatus receives a stream or a packet, which includes a moving image or a still image, from a first terminal, performs conversion that enhances resolution and image quality of the received moving image signal or still image signal, and transmits said converted signal to a terminal other than said first terminal.

### REFERENCE TO RELATED APPLICATION

This application is the National Phase of PCT/JP2009/066629, filed Sep. 25, 2009, which is based upon and claims the benefit of the priority of Japanese patent application No. 2008-248150 filed on Sep. 26, 2008, the disclosure of which is incorporated herein in its entirety by reference thereto.

### TECHNICAL FIELD

The present invention relates to a server apparatus, a communication system, a method, and a program.

### BACKGROUND

As the bandwidth of a mobile network becomes wider and its speed becomes faster, image-based communication or distribution services are expected to increase in future.

In these circumstances, when a still image signal or a moving image signal sensed by a portable terminal (mobile terminal) is once uploaded to a server, the mobile terminal side performs compression encoding of the moving image signal to efficiently transmit it at a low bit rate. As the compression encoding scheme, ITU-T (International Telecommunication Union for Telecommunication Standardization sector) Recommendation H.263 and MPEG-4 (Moving Picture Experts Group Phase 4) internationally standardized by ISO/IEC (International Organization for Standardization/International Electro technical Commission) are known. In addition, H.264/MPEG-4 AVC (Advanced Video Coding), a standard internationally standardized by ITU-T and ISO/IEC, compresses data more efficiently than the moving image compression/encoding schemes described above.

Patent Document 1 discloses a configuration in which image correction processing suitable for each device type is performed for an image received from a distribution source terminal, using a image correction parameter information adapted for a display device of a distribution destination terminal based on the distribution destination terminal information, to generate an image for distribution to the distribution destination terminal. The correction performed in the image correction processing include tone correction according to a gamma characteristic of a display device of the distribution destination terminal, hue and saturation correction through an RGB matrix operation, adjustment of sharpness, and correction of a color temperature.

Patent Document 2 discloses a configuration in which JPEG (Joint Photographic Experts Group) 2000 is used to create supplementary pixels to provide a high-quality moving image using a DSC (Distributed Source Coding) system (system in which an information source is divided, divided source signals are encoded separately, and the encoded signals are combined at decoding time for joint decoding). As will be apparent from the description below, the present invention is absolutely different from the inventions described in those Patent Documents.
Patent Document 1:
Japanese Patent Kokai Publication No. JP-P2004-120381A
Patent Document 2:
Japanese Patent Kokai Publication No. JP-P2007-74306A

### SUMMARY

The entire disclosures of Patent Documents 1-2 are incorporated herein by reference thereto. The following is an analysis made from the side of the present invention.

Because the performance, memory capacity, and function of a CPU (Central Processing Unit) included in a mobile phone are limited and because an uplink bandwidth of a mobile network is limited, resolution and image quality of a moving image signal or a still image signal transmitted from the mobile terminal to a server are not sufficient.

Another problem is that resolution and image quality are not sufficient also, when the server transmits a still image signal or a moving image signal to another mobile phone or to a mobile phone of a member belonging to another group. This makes it difficult for such services to be widely used.

A still another problem is that a downlink bandwidth of a mobile network, though expected to be increased in future, cannot be fully utilized.

It is an object of the present invention to provide a server apparatus, and a method for converting the image quality of an image received from a terminal and transmitting the converted image.

The invention provides the following general configuration, though not limited thereto.

According to one aspect of the present invention, there is provided a server apparatus comprising a conversion unit that performs conversion that enhances resolution and image quality of an image signal which includes a moving image or a still image and which is received from a first terminal; and

a transmission unit that transmits the converted image signal to at least one of terminals other than the first terminal.

According to another aspect of the present invention, there is provided a method comprising:

a server receiving an image signal which includes a moving image or a still image, from a first terminal;

a server performing conversion that enhances resolution and image quality of the received image signal; and

a server transmitting the converted image signal to at least one of terminals other than the first terminal.

According to still another aspect of the present invention, there is provided a program causing a computer, which configures a server apparatus, to execute:

conversion processing that performs conversion that enhances resolution and image quality of an image signal which includes a moving image or a still image and which is received from a first terminal and; and

transmission processing that transmits the converted image signal to at least one of terminals other than the first terminal.

According to still another aspect of the present invention, there is provided a communication system comprising at least first and second terminals; and a server apparatus connected to the first and second terminals over a network, wherein the server apparatus receives an image signal, which includes a moving image or a still image, from the first terminal, performs conversion that enhances resolution and image quality of the received image signal, and transmits the converted image signal to the second terminal.

A server apparatus, method, and system according to the present invention can convert an image quality of an image received from a terminal to transmit the converted image.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing the system configuration of the present invention.

FIG. 2 is a diagram showing the configuration of a first exemplary embodiment of a server apparatus of the present invention.

FIG. 3 is a diagram showing the configuration of a second exemplary embodiment of a server apparatus of the present invention.

FIG. 4 is a diagram showing the configuration of a third exemplary embodiment of a server apparatus of the present invention.

FIG. 5 is a diagram showing the configuration of a fourth exemplary embodiment of a server apparatus of the present invention.

FIG. 6 is a diagram showing the procedure of the first exemplary embodiment of the server apparatus of the present invention.

FIG. 7 is a diagram showing a modification of the exemplary embodiment of the server apparatus of the present invention.

### PREFERRED MODES

Modes of the present invention will be described below. In one of modes of the present invention, there is provided a server apparatus that comprises a conversion unit that receives a stream or a packet, which includes a moving image signal or a still image signal, from a first terminal and performs conversion that enhances resolution and image quality of the received moving image signal or still image signal; and a transmission unit that transmits the converted signal to a second terminal (terminal other than the first terminal). For example, the server apparatus performs conversion that enhances resolution and image quality of a moving image signal or a still image signal received from a mobile terminal, such as a mobile phone, that is the first terminal and then after, transmits the converted moving image signal or still image signal to other terminals.

In another mode of the present invention, there is provided a server apparatus that is used where two or more participating terminals form a group and that comprises a conversion unit that receives a stream or a packet, which includes a moving image signal or a still image signal, from a first terminal and performs conversion that enhances resolution and image quality of the received moving image signal or still image signal; and a transmission unit that creates one or more copies of a part or all of the converted signal and transmits the copy to the members, other than the first terminal, of the group.

In still another mode of the present invention, there is provided a server apparatus that is used where two or more participating terminals form a multicast group and that comprises a conversion unit that receives a stream or a packet, which includes a moving image signal or a still image signal, from a first terminal and performs conversion that enhances resolution and image quality of the received moving image signal or still image signal; and a transmission unit that multicasts a part or all of the converted signal to the members of the multicast group.

In still another mode of the present invention, there is provided a server apparatus that comprises a conversion unit that receives a stream or a packet, which includes a moving image signal or a still image signal, from a first terminal and performs conversion that enhances resolution and image quality of the received moving image signal or still image signal; and a transmission unit that creates one or more copies of a part or all of the converted signal and broadcasts the copies. The following describes the present invention with reference to exemplary embodiments. In the exemplary embodiments below, the configuration for using the video (moving image) signal will be described though not limited thereto.

### EXEMPLARY EMBODIMENTS

The present invention is applicable to both types of mobile network, a packet network and a circuit switched network. In the examples given below, an example in which the present invention is applied to a packet network will be described. In a packet network, an uplink bandwidth and a downlink bandwidth are asymmetric; that is, the downlink bandwidth is two or more times wider the uplink bandwidth. Therefore, in a service where video signals are used, a bit rate is reduced in the uplink while a higher bit rate may be used in the downlink.

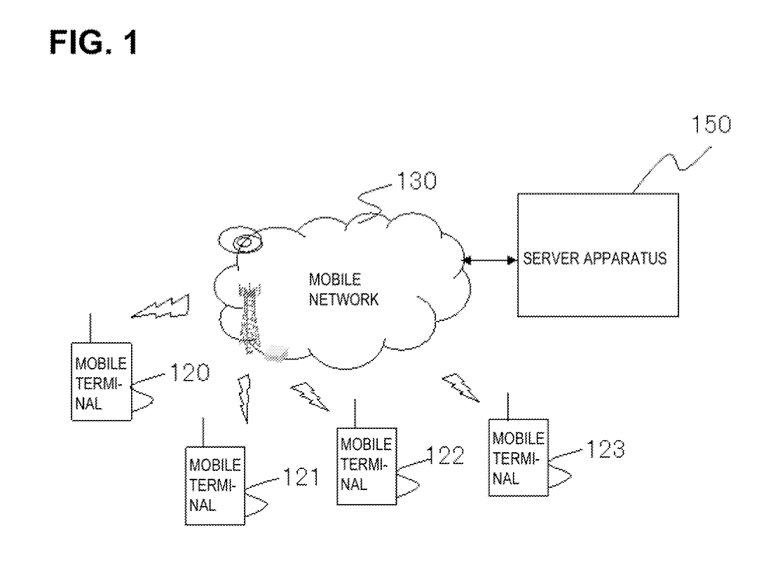

FIG. 1 is a diagram showing an example of a connection mode in which a server apparatus according to the present invention and mobile terminals are connected via a mobile network. One of mobile terminals 120-123 (for example, 120) transmits a video signal which is imaged or acquired by the terminal, to a server apparatus 150.

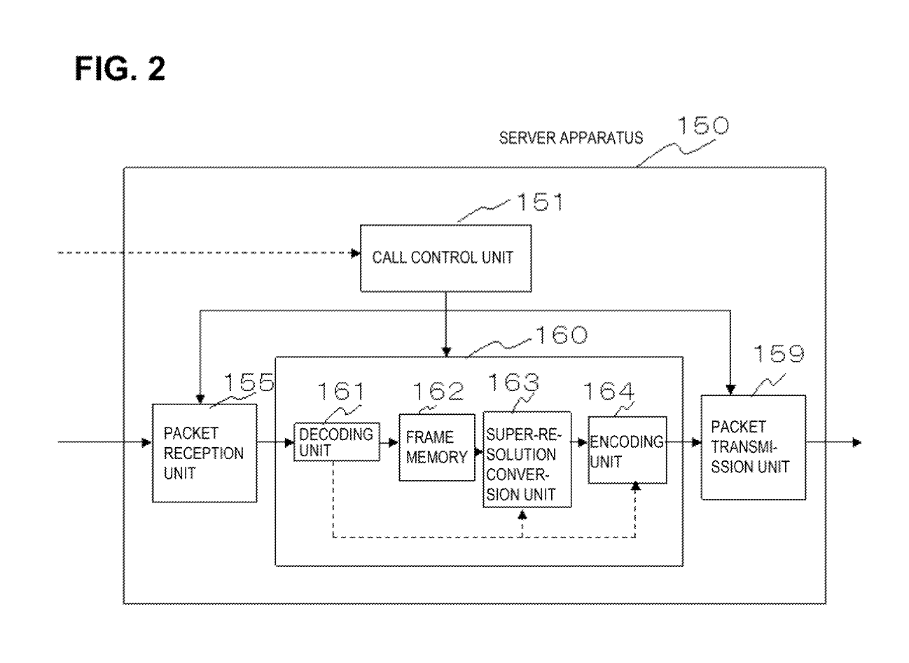

FIG. 2 is a diagram showing an example of principal portions of the configuration of the server apparatus 150 shown in FIG. 1. Referring to FIG. 2, the server apparatus 150 comprises a call control unit 151, a packet reception unit 155, a conversion unit 160, and a packet transmission unit 159. The following describes each of those elements.

The call control unit 151 receives a session control signal, which is a SIP (Session Initiation Protocol) session control signal (signal received by the call control unit 151 and indicated by the broken line), from a mobile terminal (for example, 120). In addition, the call control unit 151 receives capability information (received by the call control unit 151 and indicated by the broken line) on the mobile terminal using SDP (Session Description Protocol). The server apparatus 150 receives a session name and URI (Universal Resource Identifier) information, as well as a medium name that is a medium description, using SDP. For the detail of SIP and the detail of SDP, see IETF (Internet Engineering Task Force) RFC (Request For Comments) 3261 and IETF RFC 2327 respectively.

On reception of a session initiation indication using SIP, the call control unit 151 outputs an instruction to the packet reception unit 155 to receive an RTP (Realtime Transport Protocol) packet transmitted from the mobile terminal (for example, 120) and notifies the packet reception unit 155 of a transmission source IP address of the mobile terminal 120.

The packet reception unit 155 receives an RTP packet, transmitted from the IP address of the transmission source, extracts a compressed/encoded stream stored in a payload of the RTP packet, and outputs an extracted compressed/encoded stream to the conversion unit 160.

The conversion unit 160 comprises a decoding unit 161, a frame memory 162, a super-resolution conversion unit 163, and an encoding unit 164.

The decoding unit 161 decodes the compressed/encoded stream, received from the packet reception unit 155, using a decoder which uses the same method (for example, MPEG-4) as that of an encoder used in the mobile terminal for encoding, and stores the decoded signal in the frame memory 162.

It is assumed here that a video stream, received from the mobile terminal, conforms to the MPEG-4 SP@L0 (simple profile at level 0) standard installed in the mobile terminal (120), and has a bit rate of 64 kbps (kilobits/second), a frame rate of 15fps (frames/second), and a resolution of QCIF (Quarter Common Intermediate Format: 176×144 pixels).

The super-resolution conversion unit 163 reads a signal (decoded signal) stored in the frame memory 162 and improves the image quality by enhancing the resolution. For example, the super-resolution conversion unit 163 enhances the resolution of QCIF to the resolution of CIF (Common Intermediate Format: 352×288 pixels) or more.

To enhance the resolution, one of the following methods is used.

A technique which increases the number of pixels using a plurality of image frames, as a reference image for an image frame to be converted to enhance the resolution; and

A technique which increases the number of pixels using pixels in different positions in an image frame to be converted.

The super-resolution conversion unit 163 may be configured to select an optimal method from those methods under the constraint of an operation amount and a memory amount that may be allotted to the processing of the super-resolution conversion unit 163.

When a past (previous in time) reference frame is used for the frame to be converted, the super-resolution conversion unit 163 receives a motion vector of each of macro-blocks decoded by the decoding unit 161 and re-executes a motion vector search processing (determines a position of a macro-block which is one of macro blocks in a reference frame search range and whose difference from a macro-block of the frame to be converted is the smallest) for pixels included in a macro-block based on a motion vector to find a detailed motion vector (for example, on a half-pixel basis). And, the super-resolution conversion unit 163 may employ a configuration in which the number of pixels of the frame to be converted is increased by applying the detailed motion vector, found by the re-search, to pixels of the past reference frame and by using the frame that is moved according to the detailed motion vector. The super-resolution conversion unit 163 may also employ a configuration in which, instead of using the motion vector of macro-blocks received from the decoding unit 161, a motion vector is searched for from a frame to be converted (current frame) and a reference frame.

When only a frame whose resolution is to be enhanced is used, the super-resolution conversion unit 163 enhances resolution and improves image quality by performing processing in which an edge portion is detected and the number of pixels is increased using pixels near the edge, or pixels near the edge are corrected, or in which an edge portion is detected and is emphasized. This processing is performed for a moving image and/or a still image.

By estimating a motion direction, the super-resolution conversion unit 163 interpolates a frame image in a temporal direction (inserts one frame between preceding and following frames) and interpolates a frame rate to enhance a frame rate, for example, from 15fps to 30fps.

The encoding unit 164 receives an image signal, converted by the super-resolution conversion unit 163, and encodes the received image signal using a compression/encoding scheme that is the same as, or different from, the compression/encoding scheme of the decoding unit 161.

When the same compression/encoding scheme as that of the decoding unit 161 is adopted in the encoding unit 164, the encoding unit 164 may use, for example, “MPEG-4 SP@L3 (simple profile at level 3), CIF (512 kbps 15fps)”, instead of “MPEG-4 SP@L0, 64 kbps” which is adopted in the decoding unit 161, because the resolution and the image quality are enhanced.

On the other hand, when a compression/encoding scheme different from that of the decoding unit 161 is adopted in the encoding unit 164, a compression/encoding scheme such as “H.264 BP@L1.2 (Baseline Profile Level 1.2), CIF (512 kbps, 15fps)” may be used.

To reduce an operation amount of the motion vector search, the encoding unit 164 may also be configured to receive the motion vector information from the decoding unit 161 and, based on the received motion vector information (conversion corresponding to an enhancement in the resolution is performed for the motion vector), to search the neighborhood of the motion vector for a new motion vector for the image signal which has been converted by the super-resolution conversion unit 163.

The packet transmission unit 159 receives the compressed/encoded stream from the encoding unit 164, constructs an RTP packet with the compressed/encoded stream included in the RTP payload, and transmits the RTP packet to the destination mobile terminal.

It is also possible to configure the server apparatus to transmit the compressed/encoded stream, not as an RTP packet, but as a file in which the compressed/encoded stream is stored in a pre-defined file format (for example, 3GP file format standardized by 3GPP (Third Generation Partnership Project)). For the 3GP file format standard, see 3GPP TS26.244.

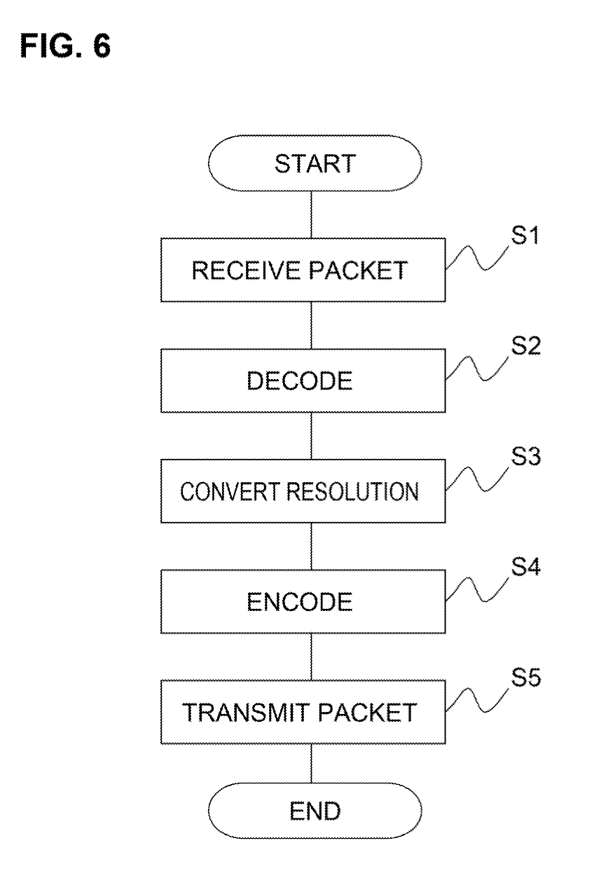

The following describes the processing procedure of the server apparatus in this exemplary embodiment with reference to FIG. 6. When a session start indication is received from a mobile terminal, the call control unit 151 of the server apparatus notifies the packet reception unit 155 of a transmission source IP address of the mobile terminal 120. The call control unit 151 receives capability information on the mobile terminal using SDP (Session Description Protocol).

Step S1: The packet reception unit 155 extracts the compressed/encoded stream from the RTP packet received from the transmission source mobile terminal and outputs the extracted compressed/encoded stream to the conversion unit 160.

Step S2: The decoding unit 161 of the conversion unit 160 decodes the compressed/encoded stream and stores the decoded image signal in the frame memory 162.

Step S3: The super-resolution conversion unit 163 reads the image signal stored in the frame memory 162 and improves the image quality by enhancing the resolution.

Step S4: The encoding unit 164 receives the image signal, converted by the super-resolution conversion unit 163, and encodes the image signal using a compression/encoding scheme that is the same as, or different from, the compression/encoding scheme of the decoding unit 161.

Step S5: The packet transmission unit 159 receives the compressed/encoded stream from the encoding unit 164 and transmits the compressed/encoded stream as an RTP packet with the compressed/encoded stream included in the RTP payload.

In the exemplary embodiment described above, any video compression/encoding scheme may be used, for example, any of H.263, MPEG-4, and H.264 may be used.

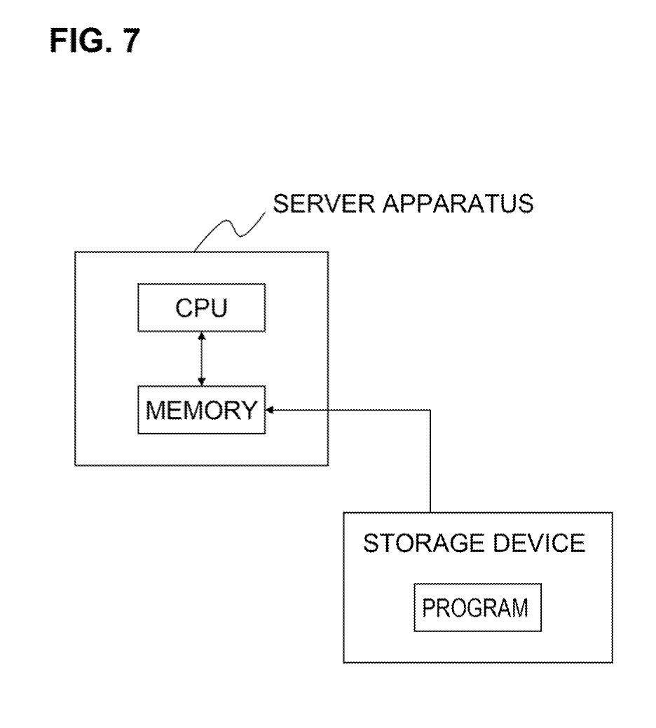

The function and the processing of steps S1 to S5 of the server apparatus described above may of course be implemented by a program executed on a computer configuring the server apparatus. The same may be said of exemplary embodiments described later. In this case, the computer (CPU) that configures the server apparatus implements the processing of the conversion unit and the processing of the packet reception unit, packet transmission unit, and call control unit by loading one or more programs from the storage device into the memory for execution as shown in FIG. 7. The storage device, in which the programs are stored, may of course be connected to the server apparatus over the network.

The following describes the effect of the first exemplary embodiment.

According to the first exemplary embodiment, the server apparatus performs the conversion that enhances resolution and image quality of a moving image signal or still image signal, received from a mobile terminal including a mobile phone, and then transmits the converted moving image signal or still image signal. This enables a high-quality image to be displayed on a user terminal.

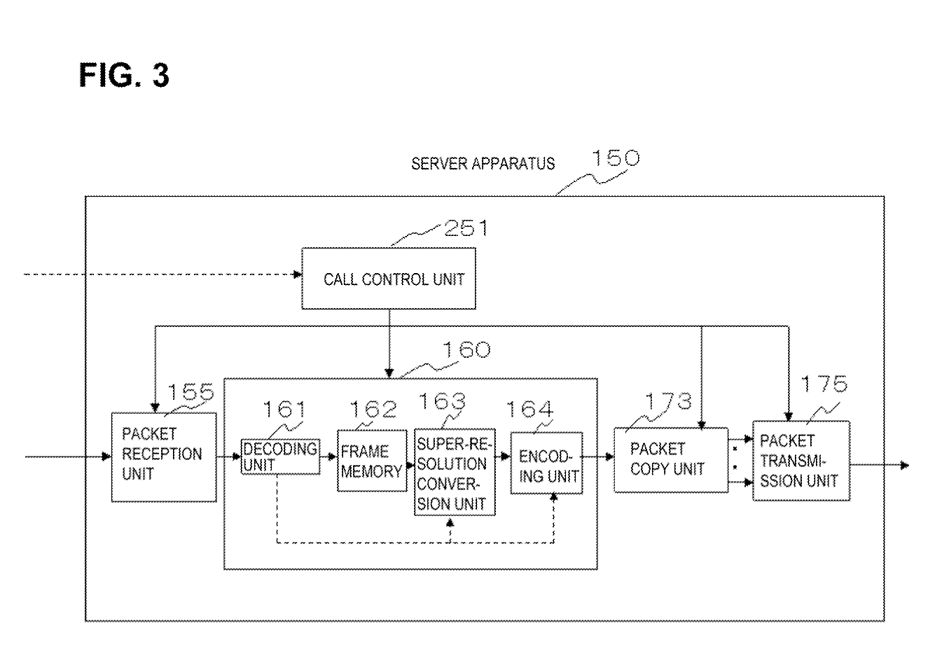

Next, a second exemplary embodiment of the present invention will be described. FIG. 3 is a diagram showing the configuration of the second exemplary embodiment of the present invention. In FIG. 3, the same reference numeral is used to denote the same element in FIG. 2. The description of the same element is omitted to avoid duplication.

A call control unit 251 receives a session control signal which includes a SIP signal, from a mobile terminal (for example, 120). The call control unit 251 also receives capability information on the mobile terminal using SDP (Session Description Protocol). The call control unit 251 also receives IP addresses of mobile terminals belonging to the same group and, after exchanging SIP and SDP information to and from the mobile terminal (for example, 120), issues an instruction to a packet reception unit 155, a conversion unit 160, a packet copy unit 173, and a packet transmission unit 175 to transfer the image signal through those units. Because the operation of the packet reception unit 155 and the operation of the conversion unit 160 are the same as those in FIG. 2, the description is omitted.

The call control unit 251 of the server apparatus 150 stores and manages the correspondence between the mobile terminals and the groups to make it possible to find the other mobile terminals that belong to the same group to which the mobile terminal (120) belongs as a member.

The packet copy unit 173 receives an instruction from the call control unit 251 indicating whether a part or all of video packets, received from the packet reception unit 155, are to be copied.

The packet copy unit 173 receives from the call control unit 251 the number of mobile terminals (N) belonging to the same group, generates (N-1) copy packets, for each of RTP packets received from the conversion unit 160, and outputs the (N-1) copy packets to the packet transmission unit 175.

The packet transmission unit 175 receives from the call control unit 251 an instruction on received IP addresses of mobile terminals belonging to the same group and transmits (N-1) RTP packets, received from the packet copy unit 173, to the IP addresses, one packet for each IP address.

The following describes the effect of the second exemplary embodiment.

According to the second exemplary embodiment, a part of all of the packets, each of which includes resolution-converted image signal, may be copied and transmitted to other members in the group to which the mobile terminal (120) belongs. That is, the server may enhance resolution and image quality of a moving image signal or a still image signal acquired by one of the mobile terminals of a group in which the mobile terminals are registered in advance, and, after that, transmit the converted moving image signal or still image signal to the mobile terminals of the group. This enables a high-quality image to be displayed on terminals of the group.

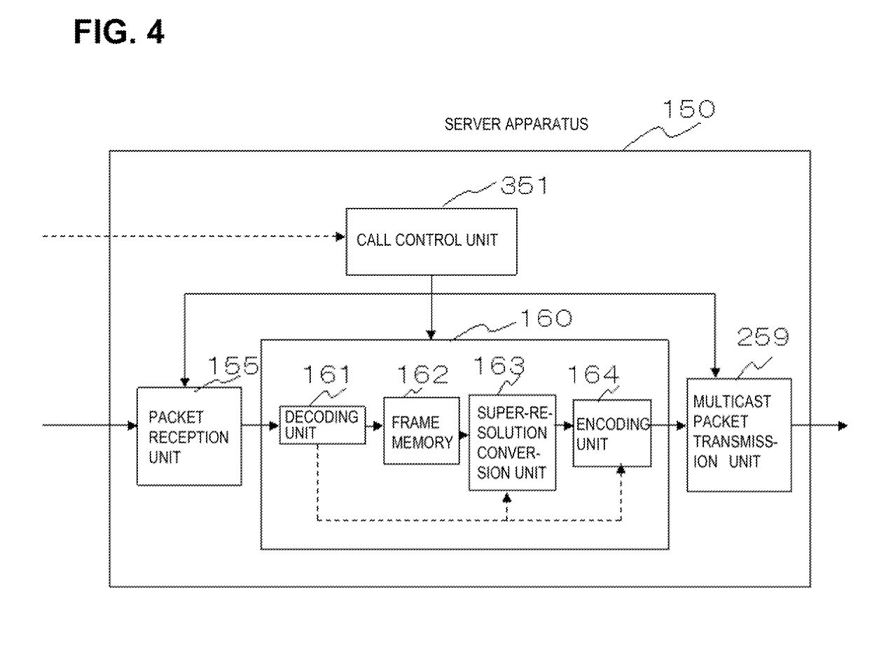

FIG. 4 is a diagram showing the configuration of a third exemplary embodiment of the present invention. In FIG. 4, the same reference numeral is used to denote the same element in FIG. 2 and FIG. 3. The description of the same element is omitted to avoid duplication. In this exemplary embodiment, a multicast packet transmission unit 259 is provided instead of the packet transmission unit in FIG. 2.

The multicast packet transmission unit 259 receives an instruction about the multicast addresses of the transmission destinations from a call control unit 351 and after that, receives a converted packet from a conversion unit 160 and transmits it to the multicast addresses.

The following describes the effect of the third exemplary embodiment of the present invention.

According to the third exemplary embodiment, a packet generated by resolution-converting an image from a mobile terminal may be multicast to the members of a multicast group. That is, a moving image signal or a still image signal is converted by enhancing resolution and improving image quality and, after that, the converted moving image signal or still image signal is multicast to the pre-registered multicast group. This allows the members of the multicast group to enjoy a high-quality image without increasing the network load even if the number of receiving mobile terminals is increased.

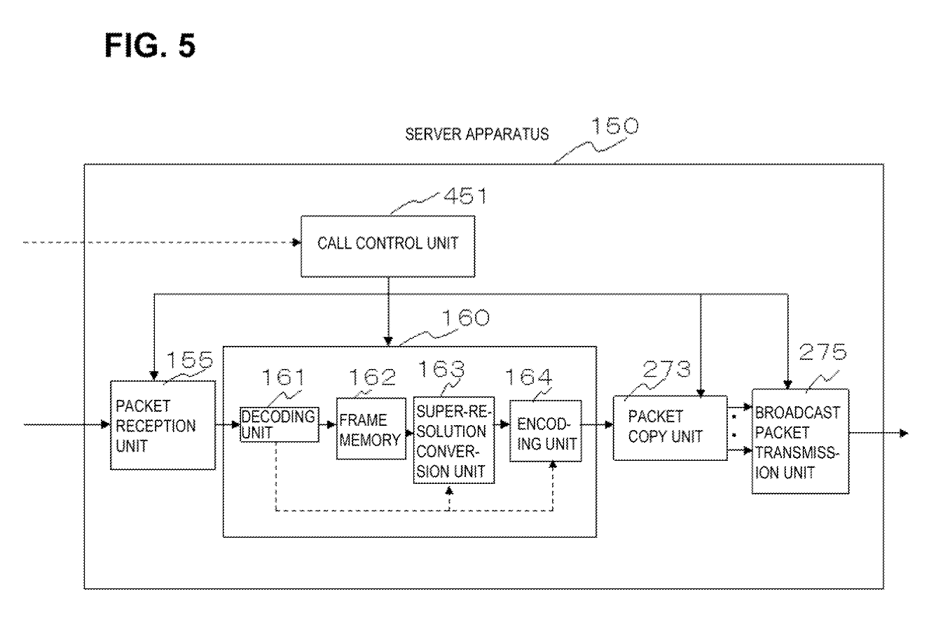

FIG. 5 is a diagram showing the configuration of a fourth exemplary embodiment of the present invention. In FIG. 5, the same reference numeral is used to denote the same element in FIG. 3. The description of the same element is omitted to avoid duplication. In this exemplary embodiment, a broadcast packet transmission unit 275 is provided as a packet transmission unit.

A call control unit 451 transmits an instruction, which indicates the number of packet copies M, to a packet copy unit 273 for broadcast transmission.

The packet copy unit 273 receives the instruction from the call control unit 451, creates M copies of the output packet received from a conversion unit 160, and outputs the copied packets to the broadcast packet transmission unit 275.

The call control unit 451 further instructs the broadcast packet transmission unit 275 to broadcast the copied packets.

The broadcast packet transmission unit 275 receives the instruction from the call control unit 451, receives the copied packets from the packet copy unit 273, and broadcasts the copies.

The following describes the effect of the fourth exemplary embodiment.

According to the fourth exemplary embodiment, a packet generated by resolution-converting an image from a mobile terminal may be broadcast. The broadcast transmission allows an unspecified number of mobile phone users to enjoy high-quality images having resolution enhanced and image quality improved.

Although the call control unit that performs the C-Plane (Control Plane) processing and the packet reception unit, conversion unit, packet copy unit, and packet transmission unit that perform the U-Plane (User Plane) processing are all stored in the server apparatus in the exemplary embodiments described above, a configuration is also possible in which the C-Plane processing and the U-Plane processing are performed in separate apparatuses.

This configuration gives scalability to C-Plane and U-Plane independently. Although a video (moving image) signal is processed in the exemplary embodiments described above, the same configuration is also possible for a still image signal.

The whole or part of the exemplary embodiments disclosed above can be described as, but not limited to the following supplementary notes.

(Supplementary note 1) A server apparatus comprises:

a conversion unit that performs conversion that enhances resolution and image quality of an image signal which includes a moving image or a still image and which is received from a first terminal; and

a transmission unit that transmits the converted image signal to at least one of terminals other than the first terminal.

(Supplementary note 2) The server apparatus according to Supplementary note 1, wherein the conversion unit comprises:

a decoding unit that decodes the image signal using a decoding scheme corresponding to an encoding scheme of the first terminal;

a resolution conversion unit that converts the resolution of the decoded signal for improving the image quality thereof; and

an encoding unit that receives and encodes the image signal converted by the resolution conversion unit.

(Supplementary note 3) The server apparatus according to Supplementary note 2, wherein

the resolution conversion unit performs motion vector re-search processing for a reference image based on a motion vector decoded by the decoding unit and, using an image generated by applying a motion vector, determined by the search, to the reference image, converts the resolution of the image signal.

(Supplementary note 4) The server apparatus according to one of Supplementary notes 1 to 3, wherein

a group composed of a plurality of terminals is generated,

an image signal including a moving image or a still image is received from the first terminal of one of the groups, and

the transmission unit creates one or more copies of a part or all of the image signal converted by the conversion unit and transmits the one or more copies to one or more member terminals, other than the first terminal, of the group.

(Supplementary note 5) The server apparatus according to one of Supplementary notes 1 to 3, wherein

a multicast group composed of two or more terminals is registered, and the transmission unit multicasts a part or all of the image signal, converted by the conversion unit, to member terminals of the multicast group.

(Supplementary note 6) The server apparatus according to one of Supplementary notes 1 to 3, wherein the transmission unit creates copies of a part or all of the image signal converted by the conversion unit and broadcasts the copies.
(Supplementary note 7) The server apparatus according to Supplementary note 4, wherein the transmission unit comprises a copy unit that creates one or more copies of a part or all of the image signal converted by the conversion unit.
(Supplementary note 8) The server apparatus according to one of Supplementary notes 1 to 7, wherein the server apparatus further comprises a reception unit that receives a packet or a stream, which includes an image signal including a moving image or a still image, from the first terminal, and the transmission unit transmits a packet or a stream, which includes an image signal including a moving image or a still image, to a terminal other than the first terminal.
(Supplementary note 9) A method comprises,

a server receiving an image signal, which includes a moving image or a still image, from a first terminal;

said server performing conversion that enhances resolution and image quality of said received image signal; and

said server transmitting an image signal resulting from said conversion to at least one of terminals other than said first terminal.

(Supplementary note 10) The method according to Supplementary note 9, wherein the server

decodes the received image signal using a decoding scheme corresponding to an encoding scheme of the first terminal;

converts the resolution of the decoded image signal for improving the image quality thereof; and

encodes the image signal whose resolution is converted.

(Supplementary note 11) The method according to Supplementary note 9 or 10, wherein a group composed of a plurality of terminals is generated, and wherein

the server receives the image signal, which includes a moving image or a still image, from the first terminal of one of the groups, and

creates one or more copies of a part or all of the converted image signal and transmits the one or more copies to one or more member terminals, other than the first terminal, in the group.

(Supplementary note 12) The method according to Supplementary note 9 or 10, wherein a multicast group composed of two or more terminals is registered, and the server multicasts a part or all of the converted image signal to members of the multicast group.
(Supplementary note 13) The method according to Supplementary note 9 or 10, wherein the server creates a plurality of copies of a part or all of the converted image signal and broadcasts the copies.
(Supplementary note 14) A program causes a computer, which configures a server apparatus, to execute:

conversion processing that converts an image signal, which is received from a first terminal and includes a moving image or a still image, by enhancing resolution and image quality thereof; and

transmission processing that transmits the converted image signal to at least one of terminals other than the first terminal.

(Supplementary note 15) The program according to Supplementary note 14, wherein the conversion processing includes:

decoding processing that decodes the image signal, received by the reception unit, using a decoding scheme corresponding to an encoding scheme of the terminal;

resolution conversion processing that converts the resolution of the decoded signal for improving the image quality thereof; and

encoding processing that receives and encodes the converted image signal.

(Supplementary note 16) The program according to Supplementary note 14 or 15, wherein the image signal, which includes a moving image or a still image, is received from the first terminal of one of groups, and the transmission processing creates one or more copies of a part or all of the converted image signal and transmits the one or more copies to one or more member terminals, other than the first terminal, in the group.
(Supplementary note 17) The program according to Supplementary note 14 or 15, wherein the transmission processing multicasts a part or all of the converted image signal to members of the multicast group.
(Supplementary note 18) The program according to Supplementary note 14 or 15, wherein the transmission processing creates a plurality of copies of a part or all of the converted image signal and broadcasts the copies.
(Supplementary note 19) A system comprises:

at least first and second terminals; and

a server apparatus connected to the first and second terminals over a network wherein

the server apparatus

receives an image signal, which includes a moving image or a still image, from the first terminal,

performs conversion that enhances resolution and image quality of the received image signal, and

transmits the converted image signal to the second terminal.

(Supplementary note 20) The system according to Supplementary note 19, wherein the server apparatus

decodes the received image signal using a decoding scheme corresponding to an encoding scheme of the terminal,

converts the resolution of the decoded signal for improving the image quality thereof; and

encodes the image signal whose resolution is converted.

(Supplementary note 21) The system according to Supplementary note 19 or 20, wherein at least the first and second terminals participate to form a group, and

the server apparatus

receives the image signal, which includes a moving image or a still image, from the first terminal of one of the groups,

creates one or more copies of a part or all of the converted image signal, and

transmits the copy to terminals, other than the first terminal, of the group, the terminals at least including the second terminal.

(Supplementary note 22) The system according to Supplementary note 19 or 20, wherein a multicast group, which includes at least said first and second terminals, is registered, and the server apparatus multicasts a part or all of the converted image signal to members of the multicast group.
(Supplementary note 23) The system according to Supplementary note 19 or 20, wherein the server apparatus creates a plurality of copies of a part or all of the image signal converted by the conversion unit and broadcasts the copies.

The disclosure of Patent Documents given above is hereby incorporated by reference into this specification. The exemplary embodiments and the examples may be changed and adjusted in the scope of the entire disclosure (including claims) of the present invention and based on the basic technological concept. In the scope of the claims of the present invention, various disclosed elements may be combined and selected in a variety of ways. That is, it is apparent that the present invention includes various modifications and changes that may be made by those skilled in the art according to the entire disclosure, including claims, and technological concepts thereof.

What is claimed is:

1. A server apparatus comprising:
a conversion unit that performs conversion that enhances resolution and image quality of an image signal which includes a moving image or a still image and which is received from a first terminal; and
a transmission unit that transmits said converted image signal to at least one terminal other than said first terminal.

2. The server apparatus according to claim 1, wherein said conversion unit comprises:
a decoding unit that decodes said image signal using a decoding scheme corresponding to an encoding scheme of said first terminal;
a resolution conversion unit that converts resolution of said decoded image signal to improve image quality thereof; and
an encoding unit that receives and encodes an image signal converted by said resolution conversion unit.

3. The server apparatus according to claim 2, wherein said resolution conversion unit performs motion vector re-search processing for a past reference image, based on a motion vector decoded by said decoding unit, and using an image generated by applying a motion vector, found by said re-search, to said reference image, converts resolution of said image signal.

4. The server apparatus according to claim 1, wherein a plurality of terminals form one or more groups, and wherein
said server apparatus receives an image signal including a moving image or a still image from said first terminal of one of said groups, and
said transmission unit creates one or more copies of a part or all of an image signal converted by said conversion unit and transmits said one or more copies to one or more member terminals, other than said first terminal, in said one group.

5. The server apparatus according to claim 1, wherein a multicast group composed of two or more terminals is registered, and
said transmission unit multicasts a part or all of said image signal, converted by said conversion unit, to member terminals of said multicast group.

6. The server apparatus according to claim 1, wherein said transmission unit creates a plurality of copies of a part or all of said image signal converted by said conversion unit and broadcasts said copies.

7. The server apparatus according to claim 1, wherein said transmission unit comprises a copy unit that creates one or more copies of a part or all of said image signal converted by said conversion unit.

8. The server apparatus according to claim 1, further comprising
a reception unit that receives a packet or a stream, which includes an image signal including a moving image or a still image, from said first terminal, wherein
said transmission unit transmits a packet or a stream, which includes an image signal including a moving image or a still image, to a terminal other than said first terminal.

9. A communication method using a server, said method comprising:
receiving an image signal, which includes a moving image or a still image, from a first terminal;
performing conversion that enhances resolution and image quality of said received image signal; and
transmitting an image signal resulting from said conversion to at least one of terminals other than said first terminal.

10. The communication method according to claim 9, further comprising:
decoding said received image signal using a decoding scheme corresponding to an encoding scheme of said first terminal;
converting resolution of said decoded image signal to improve image quality thereof; and
encoding said image signal whose resolution is converted.

11. The communication method according to claim 9, wherein a plurality of terminals form one or more groups, said method comprising:
receiving said image signal, which includes a moving image or a still image, from said first terminal of one of said groups, and
creating one or more copies of a part or all of said converted image signal and transmitting said one or more copies to one or more member terminals, other than said first terminal, in said one group.

12. The communication method according to claim 9, wherein a multicast group composed of two or more terminals is registered, said method comprising
multicasting a part or all of said converted image signal to member terminals of said multicast group.

13. The communication method according to claim 9, comprising
creating a plurality of copies of a part or all of said converted image signal and broadcasting said copies.

14-18. (canceled)

19. A communication system comprising:
at least first and second terminals; and
a server apparatus connected to said first and second terminals over a network, wherein said server apparatus comprises:
a reception unit that receives an image signal, which includes a moving image or a still image, from said first terminal;
a conversion unit that performs conversion that enhances resolution and image quality of said received image signal; and
a transmission unit that transmits said converted image signal to said second terminal.

20. The communication system according to claim 19, wherein said server apparatus further comprises:
a decoding unit decodes said received image signal using a decoding scheme corresponding to an encoding scheme of said first terminal;
a resolution conversion unit that converts resolution of said decoded image signal to improve said image quality thereof; and
an encoding unit that encodes said image signal whose resolution is converted.

21. The communication system according to claim 19, wherein at least said first and second terminals form a group, and wherein said server apparatus comprises:
said reception unit that receives an image signal, which includes a moving image or a still image, from said first terminal of one of said groups;
a copy unit that creates one or more copies of a part or all of said converted image signal; and
said transmission unit that transmits said one or more copies copy to one or more terminals including at least said second terminal, other than said first terminal, in said group.

22. The communication system according to claim 19, wherein a multicast group is registered in said server apparatus, said multicast group including at least said first and second terminals, and said transmission unit of
said server apparatus multicasts a part or all of said converted image signal to member terminals of said multicast group.

23. The communication system according to claim 19, wherein said server apparatus comprises
a copy unit that creates a plurality of copies of a part or all of said image signal converted by said conversion unit, and
said transmission unit of said server apparatus broadcasts said copies.
